(19) United States
(12) Patent Application Publication
(10) Pub. No.: US 2011/0022518 A1
(43) Pub. Date: Jan. 27, 2011

(54) APPARATUS INCLUDING DATA BEARING MEDIUM FOR SEASONING A DEVICE USING DATA OBTAINED FROM MULTIPLE TRANSACTION ENVIRONMENTS

(76) Inventor: Ayman Hammad, Pleasanton, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 12/507,757

(22) Filed: Jul. 22, 2009

(51) Int. Cl. G06Q 40/00; G06K 5/00

(52) U.S. Cl. 705/44; 235/380

(57) ABSTRACT

An apparatus includes a processor and a set of instructions stored in a memory, where when executed by the processor, the instructions implement a method or process of determining if a consumer device should be accepted as valid based on correlating a location of the device with a location of a different transaction involving the same account. This enables an authorization decision for a transaction to be made at an earlier stage of the overall authorization process, or with less data processing or computational resources than might otherwise be required.

### CROSS-REFERENCES TO RELATED APPLICATIONS

The following patent applications are incorporated by reference in their entirety: U.S. patent application Ser. No. ______, entitled “An Apparatus Including Data Bearing Medium For Authorizing a Payment Transaction Using Seasoned Data” (Attorney Docket No. 016222-043100US) and U.S. patent application Ser. No. ______,entitled “An Apparatus Including Data Bearing Medium for Reducing Fraud in Payment Transactions Using a Blacklist” (Attorney Docket No. 016222-045300US) each filed on Jul. 22, 2009.

### BACKGROUND

Embodiments of the present invention are directed to systems, apparatuses and methods for enabling electronic payments and the processing of payment transaction data, and more specifically, to the seasoning of a device or account used in an electronic payment transaction using data obtained from multiple transaction environments. The inventive method and associated systems and apparatuses may be used to expedite the authorization of future transactions initiated using the device or account by associating the device or account with data obtained from both card present and card not present transactions, for example using the card present transaction to assist in validating a device used in a card not present transaction. The invention may also be used to determine if a device used to initiate a transaction is being used in a fraudulent manner in the situation where the device location is not associated with the location of the owner of an account or the location associated with one or more card present transactions.

Consumer payment devices such as debit cards or credit cards are used by millions of people worldwide to facilitate various types of commercial transactions. In a typical transaction involving the purchase of a product or service at a merchant location, the payment device is presented at a point of sale terminal (“POS terminal”) located at a merchant's place of business. The POS terminal may be a card reader or similar device that is capable of accessing data stored on the payment device, where the data may include identification or authentication data, for example. Some or all of the data read from the payment device is provided to the merchant's transaction processing system and then to the Acquirer, which is typically a bank or other institution that manages the merchant's account. The data provided to the Acquirer may then be provided to a payment processing network (e.g., a payment processor) which processes the data to determine if the transaction should be authorized by the network, and assists in the clearance and account settlement functions of the transaction. The authorization decision and clearance and settlement portions of the overall transaction may also involve communication and/or data transfer between the payment processor and the bank or institution that issued the payment device to the consumer (the Issuer). Transactions in which a consumer payment device is presented to a merchant or accessed by a point of sale terminal are termed “card present” transactions since the payment device is in the same physical location as the merchant or terminal.

In addition to card present transactions, a consumer may also initiate a transaction in a situation in which the payment device is not in the same physical location as the merchant or terminal, and instead the relevant data is provided over a communications network to the merchant (termed a “card not present” transaction). For example, a transaction involving the purchase of a product or service may be initiated by a consumer by providing payment data from a remote location to a merchant over a network such as the Internet. Transactions of this type are typically initiated using a computing device such as a personal computer or laptop computer. Transactions may also be initiated by using a mobile device such as a cell phone or personal data assistant (PDA) that communicates with a merchant or service provider directly or indirectly over a wireless network (which may be configured to enable data transfer between the wireless network and the Internet). Thus, payment information for a transaction may be provided using a payment device and point of sale terminal, a remotely located computing device, or a mobile device capable of wireless communications, among other methods.

In an E-commerce environment in which a credit card or debit card is typically not presented to a merchant, authorization of a transaction initiated using a consumer device may be contingent on the device or the account being used for the transaction having a sufficient history of being used for successful transactions (i.e., not fraudulent or questionable transactions). In the absence of a sufficient transaction history, the consumer may be denied authorization for a transaction initiated using a new device (such as a new computer or mobile phone) or account, or issued a challenge message that they must respond to in order for the authentication process to continue. In addition to the data processing burden this places on the payment network, this can frustrate a consumer and have a negative impact on their use of the payment network for future transactions.

Because issuing a challenge requires use of valuable data processing and network resources and creates a less desirable experience for the consumer, it is desirable to identify those consumer devices that can be considered reliable and trustworthy enough to permit authorization of transactions initiated using those devices or of the account used for the transaction without the need for additional verification data. One way to accomplish this is to identify which consumer devices or accounts can be accepted as “seasoned” and then provide expedited authorization for transactions using such devices or accounts. However, this process is complicated because transactions involving the same account may be initiated in both card present and card not present situations, and using multiple consumer devices.

What is desired is a system, apparatus and method for expediting the authorization process for electronic payment transactions by determining which of multiple consumer devices used to initiate a transaction or accounts used for a transaction should be considered seasoned. Embodiments of the invention address these problems and other problems individually and collectively.

### SUMMARY

Embodiments of the present invention are directed to a system, apparatus, and method for expediting the authorization of an electronic payment transaction by determining which of a set of consumer devices used to initiate transactions should be considered “seasoned”, where “seasoning” refers to the concept of being accepted as a reliable and trustworthy party to a transaction. In some embodiments, the invention is directed to an apparatus that includes a processor and a set of instructions stored in a memory, where when executed by the processor, the instructions implement a method or process of determining if a consumer device should be accepted as valid based on correlating a location of the device with a location of a different transaction involving the same account. This enables an authorization decision for a transaction to be made at an earlier stage of the overall authorization process, or with less data processing or computational resources than might otherwise be required.

For example, expedited authorization for a transaction might eliminate the necessity to send a challenge or data inquiry to a consumer in a situation in which there has been a change in consumer or payment device data that would normally have prevented authorization of the transaction. Use of data collected in both card present and card not present situations enables a data processor to more rapidly identify a consumer device or account as valid and can also be used to determine which of multiple consumer devices is likely to be being used in a fraudulent manner. In some embodiments, this is accomplished by determining that a consumer device such as a computer or mobile phone or a specific account can be categorized as “seasoned” based on fewer contacts with a merchant, where as noted “seasoning” refers to the concept of being accepted as a reliable and trustworthy party to a transaction.

In one embodiment, the present invention is directed to an apparatus for authorizing an electronic payment transaction for a consumer, where the apparatus includes a processor configured to execute a set of instructions, a memory coupled to the processor for storing the set of instructions, and the set of instructions stored in the memory, wherein when executed by the processor the instructions implement a method to receive transaction data including an IP address and an account number for a first transaction, receive transaction data including the account number for a second transaction, the second transaction being conducted at a merchant in a card present transaction, determine if the first and second transactions were conducted in approximately the same geographic location, and if the first and second transactions were conducted in approximately the same geographic location, then identify the device with the IP address as seasoned.

In another embodiment, the present invention is directed to a method, where the method includes receiving transaction data including an IP address and an account number for a first transaction, receiving transaction data including the account number for a second transaction, the second transaction being conducted at a merchant in a card present transaction, determining if the first and second transactions were conducted in approximately the same geographic location, and if the first and second transactions were conducted in approximately the same geographic location, then identifying the device with the IP address as seasoned.

In yet another embodiment, the present invention is directed to a method and an apparatus including a processor for executing a set of instructions that implement the method, where the method includes receiving data for a card present transaction, the data including an account number, receiving data for a first card not present transaction initiated by a first consumer device, the data including the account number, receiving data for a second card not present transaction initiated by a second consumer device, the data including the account number, determining a location for the card present and the first and second card not present transactions, determining if the location for the first card not present transaction is approximately the same as the location for the card present transaction, wherein if the location for the first card not present transaction is approximately the same as the location for the card present transaction, then identifying the first consumer device as seasoned, and determining if the location for the second card not present transaction is approximately the same as the location for the card present transaction, wherein if the location for the second card not present transaction is approximately the same as the location for the card present transaction, then identifying the second consumer device as seasoned.

In another embodiment, the present invention is directed to a method and an apparatus including a processor for executing a set of instructions that implement the method, where the method includes receiving data for a card present transaction, receiving data for a card not present transaction initiated by a consumer device, identifying a data category of the data for the card present transaction that is equivalent to a data category of the data for the card not present transaction, comparing a value of data in the data category of the data for the card present transaction to a value of data in the data category of the data for the card not present transaction, and identifying the consumer device as seasoned if the value of data in the data category of the data for the card present transaction and the value of data in the data category of the data for the card not present transaction are approximately the same.

Other objects and advantages of the present invention will be apparent to one of ordinary skill in the art upon review of the detailed description of the present invention and the included figures.

### BRIEF DESCRIPTION OF THE DRAWINGS

FIG. 1 is a functional block diagram illustrating the primary functional elements of an exemplary system for authorizing an electronic payment transaction;

FIG. 2 is a flowchart illustrating a method for seasoning a consumer device used in a card not present transaction, in accordance with some embodiments of the present invention;

FIG. 3 is a flowchart illustrating a second method for seasoning a consumer device used in a card not present transaction, in accordance with some embodiments of the present invention; and

FIG. 4 is a block diagram of elements that may be present in a computer device or system configured to execute a method or process for expediting the authorization of a payment transaction in accordance with some embodiments of the invention.

### DETAILED DESCRIPTION

Before proceeding to describe one or more embodiments of the present invention, and to assist with providing a better understanding of the invention, it may be useful to define some terms that will be used in describing the inventive system and method. In the context of the present invention:

A “consumer” is a customer to a transaction, or user of a payment device or device into which payment data may be entered and provided to a merchant as part of a transaction.

A “payment device” is a credit card, debit card, or other device or element from which payment data may be read or otherwise communicated. Payment devices are typically used in “card present” transactions.

A “consumer device” is a device into which a consumer enters payment or account data, or in which previously entered data is stored, with that data being communicated to a merchant as part of a transaction. Example consumer devices include, but are not limited to, home or business computers, mobile phones, PDAs, laptop computers, and the like. Consumer devices are typically used in “card not present” transactions in which payment data is communicated to a merchant over a communications network, such as the Internet.

“Seasoning” refers to a process of determining that transactions associated with a particular consumer, account, or consumer device may be taken to be sufficiently trustworthy to authenticate current or future transactions associated with that consumer, account, or consumer device without the normal authentication process, or without issuing a challenge or other request for approval in a situation in which a challenge would normally be issued. Seasoning expedites the authentication process, and indicates a preferred or reliable status for the consumer, account or consumer device. In practice, a seasoned account might be approved for a transaction in a situation in which an issuing bank declined the transaction, or be eligible for discounts or other special treatment.

A “challenge” is a message or other form of communication in which additional information or an action is requested from a consumer as a pre-condition to authorizing a transaction. A payment processor may issue a challenge in situations in which a consumer has initiated a transaction using a new consumer device, payment method or account for a transaction, where the device, method, or account has not previously been “seasoned”.

Embodiments of the present invention are directed to a system, apparatus, and method for expediting all or part of the authorization process involved in an electronic payment transaction. The invention may be used to identify a consumer device or account as seasoned based on determining device or transaction data for a card not present transaction initiated using the device or account that is consistent with transaction data for a card present transaction. In some embodiments, the data is the location or other geographic information associated with a card present transaction and which is consistent with that for a card not present transaction initiated using the consumer device or account.

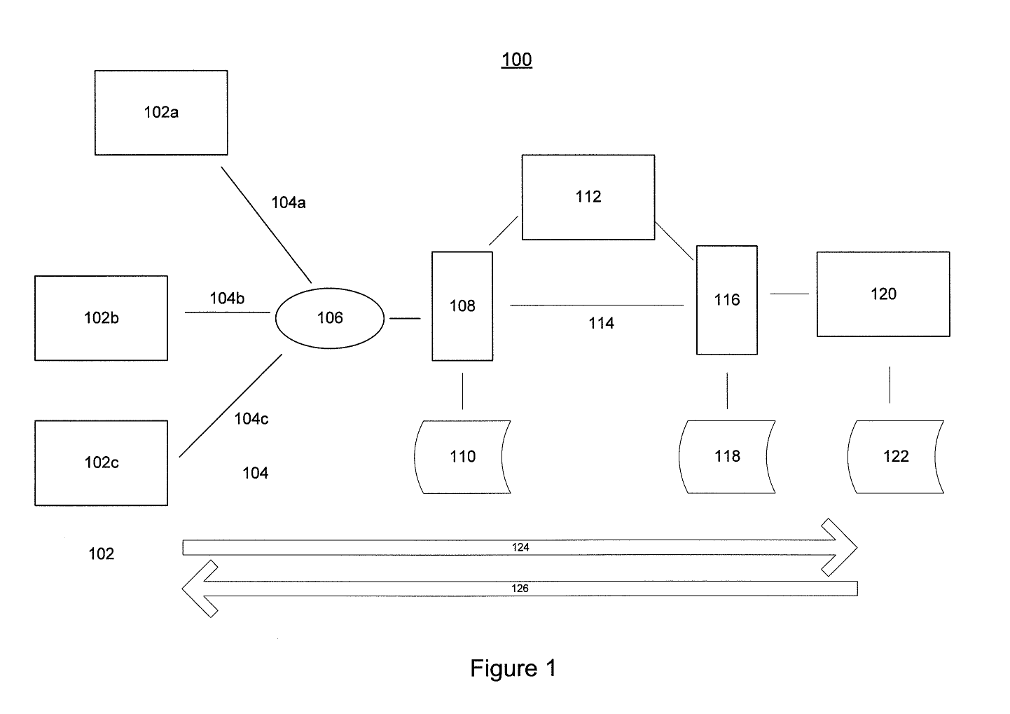

Prior to describing one or more embodiments of the invention in greater detail, a brief discussion of the entities involved in authorizing an electronic payment transaction and their roles in the authorization process will be presented with regards to FIG. 1, which is a functional block diagram illustrating the primary functional elements of an exemplary system 100 for authorizing an electronic payment transaction. As shown in FIG. 1, in a typical transaction, a consumer wishing to purchase a good or service from a merchant provides payment transaction data that may be used as part of an authorization process by means of a device 102. The consumer may utilize a payment device such as a card having a magnetic strip encoded with account data or other relevant data (e.g., a standard credit or debit card) to initiate the transaction. In an E-commerce transaction, the consumer may enter data into a consumer device capable of communicating with a merchant or other element of system 100, such as a laptop or personal computer. The consumer may also initiate the transaction using data stored in and provided from a suitable form of data storage device (such as a smart card, mobile phone, PDA, or transportable memory device). As examples, a card or similar payment device may be presented to a point of sale terminal 102a which scans or reads data from that card. Similarly, a consumer may enter payment account data into a computing device 102b, as part of an E-commerce transaction. Further, a consumer may enter payment account data into a cell phone or other wireless device 102c and have that data communicated to the transaction authorization network by the device (or have previously entered and stored data that is accessed and provided to the network as part of the transaction).

The payment account data (as well as any required consumer data) is communicated over a communication network 106 to the merchant and ultimately to the merchant's transaction processing system 108. The data may be provided to communication network 106 by any method or elements suitable for use with device 102. For example, if device 102 is a point of sale terminal 102a, then the data may be provided by a wireline phone connection or suitable form of connection to the Internet 104a. If device 102 is a consumer's computing device 102b, then the data may be provided by a connection to the Internet 104b, such as a cable modem or wireless router. If device 102 is a cell phone or other wireless device 102c, then the data may be provided by a wireless network 104c to communication network 106. Depending on the merchant or transaction involved, communication network 106 may be the Internet, a closed network such as a corporate network, a wireless network, or other suitable form of data transport channel.

As part of the authorization process performed by the merchant, merchant transaction processing system 108 may access merchant database 110, which typically stores data regarding the customer/consumer (as the result of a registration process with the merchant, for example), the consumer's payment device, and the consumer's transaction history with the merchant. Merchant transaction processing system 108 typically communicates with Merchant Acquirer 112 (which manages the merchant's accounts) as part of the overall authorization process. Merchant transaction processing system 108 and/or Merchant Acquirer 112 provide data to Payment Processing Network 116, which among other functions, participates in the clearance and settlement processes which are part of the overall transaction processing. Communication and data transfer between Merchant transaction processing system 108 and Payment Processing Network 116 may be by means of a direct connection 114 or by means of an intermediary, such as Merchant Acquirer 112. As part of the transaction authorization process, Payment Processing Network 116 may access account database 118, which typically contains information regarding the consumer's account payment history, chargeback or dispute history, credit worthiness, etc. Payment Processing Network 116 communicates with Issuer 120 as part of the authorization process, where Issuer 120 is the entity that issued the payment device (or provided another form of data to enable a consumer to pay for goods or services) to the consumer and manages the consumer's account. Customer or consumer account data is typically stored in customer/consumer database 122 which is accessed by Issuer 120 as part of the authorization and account management processes.

In standard operation, an authorization request message is created during or after a consumer purchase of a good or service at a point of sale (POS). The point of sale may be a merchant's physical location or a virtual point of sale such as a web-site that is part of an E-commerce transaction. In a typical transaction, the authorization request message is sent from the point of sale to the merchant's Acquirer 112, to a Payment Processing Network 116, and then to an Issuer 120. An “authorization request message” can include a request for authorization to conduct an electronic payment transaction. It may include one or more of an account holder's payment account number, currency code, sale amount, merchant transaction stamp, acceptor city, acceptor state/country, etc. An authorization request message may be protected using a secure encryption method (e.g., 128-bit SSL or equivalent) in order to prevent data from being compromised. In a typical transaction authorization process, an authorization request message is communicated between nodes as indicated by arrow 124 in FIG. 1, while an authorization response (i.e., an approval or denial by an issuer or payment processing network) is communicated between nodes as indicated by arrow 126 in FIG. 1.

Payment Processing Network 116 may include data processing subsystems, networks, and other means of implementing operations used to support and deliver authorization services, exception file services, and clearing and settlement services for payment transactions. An exemplary Payment Processing Network may include VisaNet™. Payment Processing Networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services.

Payment Processing Network 116 may include a server computer. A server computer is typically a powerful computer or cluster of computers. For example, the server computer can be a large mainframe, a minicomputer cluster, or a group of servers functioning as a unit. In one example, the server computer may be a database server coupled to a web server. Payment Processing Network 116 may use any suitable wired or wireless network, including the Internet to permit communication and data transfer between network elements. Among other functions, Payment Processing Network 116 may be responsible for ensuring that a user is authorized to conduct the transaction (via an authentication process), confirm the identity of a party to a transaction (via receipt of a personal identification number), confirm a sufficient balance or credit line to permit a purchase, and reconcile the amount of purchase with the user's account (via entering a record of the transaction amount, date, etc.).

As depicted in FIG. 1, the authorization of a transaction typically involves decisions made at multiple nodes or elements of the overall authorization or transaction processing network. These nodes include, but are not limited to, the merchant, the merchant's Acquirer, the payment processor, and the Issuer. Each node may have access to its own data regarding the consumer, the payment device, the consumer's transaction history with a merchant or set of merchants, the consumer's payment history, and fraudulent activities concerning the consumer's account or device, with this data typically not exchanged between nodes. Further, each node will typically have its own rules or guidelines for deciding if a particular transaction should be authorized, based on the transaction data and the node's own data and decision making rules.

In addition to authorization decisions made for a specific transaction based on the data for that transaction, a node in the authorization network may decline to authorize a transaction because of the consumer device or account that initiated the transaction. For example, a node in the authorization network may decline to authorize a transaction made by a consumer's computer or cell phone if that device or the account being used for the transaction had not been previously involved with a sufficient number of valid transactions, i.e., had not been sufficiently “seasoned”. In a situation in which a consumer device or account being used to initiate a transaction is not sufficiently seasoned, a node of the authorization network may send a challenge to the consumer, requiring them to provide additional information prior to the node making an authorization decision. A challenge consumes valuable computational and network resources and may inconvenience users, thereby causing a delay in the authorization of a transaction and causing the consumer to be less likely to initiate transactions in the future. In addition, this situation may prevent a merchant from accepting a transaction from a customer that has been qualified as reliable and trustworthy by others, or one initiated by a device that is associated with a previously “seasoned” account.

In order to overcome these disadvantages of the present authorization system, and to expedite authorization of a specific transaction or the seasoning of a consumer device or consumer account, in some embodiments, the present invention introduces the concept of using data from both a card present transaction and a card not present transaction (e.g., an E-commerce transaction) to expedite the seasoning of the consumer device or account. This may be accomplished by associating specific consumer device or account data with data obtained from a presumably valid card present transaction, thereby concluding that the consumer device or account is reliable and entitled to be considered seasoned. In some embodiments, the specific device data is its location or related geographic data (or for an account, the location associated with the transaction using that account), and the similarity or consistency between the location data for the card present and the card not present transactions is used as the basis for seasoning the device or account, authorizing the transaction, or expediting the authorization of future transactions. Note that in addition to other uses, the invention may be used to determine that a consumer device is reliable and eligible to be considered seasoned, or to determine which of two or more consumer devices should be considered the valid one for purposes of authorizing a transaction.

Further, in some embodiments, the present invention includes an apparatus and process for identifying a similar data type or data category in data provided from a card present transaction and from a card not present transaction, and then determining if the values of that data type from each of the transactions are similar enough to justify considering the consumer device or account used to initiate the card not present transaction as reliable (i.e., seasoned). In this way confidence in the reliability or trustworthiness of the card present transaction data is used to justify seasoning of the consumer device or account used for the card not present transaction, where this determination is based on comparison of specific data values in the device, account or transaction data for the two transactions.

In general, embodiments of the invention include, but are not limited to, being implemented as part of the following actions or transaction data processing stages, with each such action or transaction data processing stage capable of being implemented in the form of an apparatus that includes a processor executing a set of instructions, or as a method or system, among other embodiments:
Processing of data obtained from a card present transaction to determine a location or other geographic region in which the transaction occurred;
   Processing of data obtained from a card not present transaction initiated using a consumer device (e.g., a desktop or laptop computer, PDA, mobile phone) to determine a location or other geographic region in which the consumer device is located (similarly, card not present transaction data may be used to determine a location or geographic region from which a transaction using a specified account is initiated);
   Comparison of the location or geographic region data for the two transactions to determine if they are sufficiently similar (e.g., substantially the same or approximately the same); and
   Authorization of the card not present transaction and/or identifying the consumer device or account as seasoned if the two sets of data are sufficiently similar.
Processing of data from a card not present transaction to determine if a consumer device or account used to initiate the transaction should be considered reliable or seasoned based on comparison of specific transaction or device data with that from a card present transaction. This may be used to determine if a consumer device or account should be considered seasoned or to determine which of several transactions should be considered valid, where each transaction is initiated by a different consumer device; and
Processing data from a card present and card not present transaction to determine data that is consistent or sufficiently similar between the two transactions and then determining if the consistent or sufficiently similar data justifies identifying the consumer device or account as seasoned.

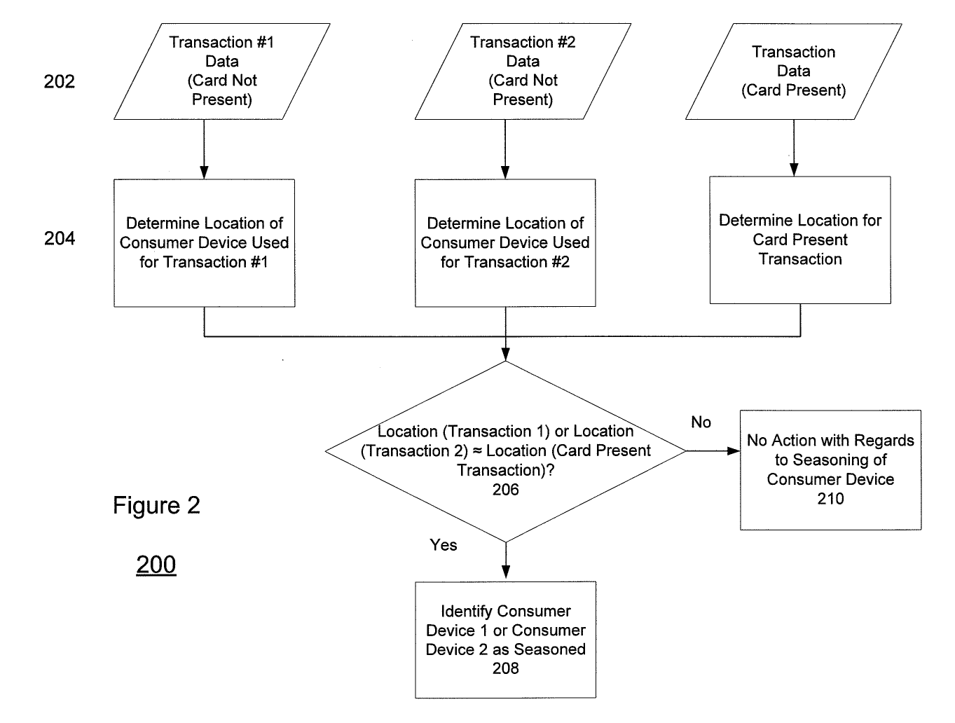

These and other embodiments of the invention will now be described in greater detail with reference to FIGS. 2-4, where FIG. 2 is a flowchart illustrating a method for seasoning a consumer device used in a card not present transaction, in accordance with some embodiments of the present invention. FIG. 2 illustrates a group of steps or stages that represent an implementation of an embodiment of the invention. It is noted that the steps or stages shown in the figure may represent the entire process of determining that a consumer device should be considered seasoned, or only a portion of the overall process. Further, although the process described with reference to FIG. 2 will typically be performed by a processor executing a set of instructions, for example a payment processing network node, it may also be performed by other nodes of an authorization network.

Referring to FIG. 2, transaction data and device data, either alone or in combination is received from a set of transactions (stage 202). The set of transactions includes one card present transaction and one or more card not present transactions (labeled Transaction #1 and Transaction #2 in the figure). Exemplary card not present transactions include E-commerce transactions initiated by a consumer device in communication with a remote merchant over a communications network. Exemplary card present transactions include purchases at a merchant's physical location or via a point of sale terminal (such as at a gas station, etc.). Note that the card not present transactions may be one or more in number, with the invention determining whether the consumer device or account used for the card not present transaction is reliable and should be considered seasoned (in the case of one such transaction) or determining which (if any) of several consumer devices used to initiate transactions is reliable and should be considered seasoned (in the case of more than one such transaction). Note also that although shown as providing the transaction or device data in the same stage, embodiments of the invention include providing the data separately over a period of time, with previously received data being stored and accessed as needed for the data processing stages of the invention.

In some embodiments, the received data is device identification data that may be contained in an authorization message. In some embodiments, the device identification data is information sufficient to determine a location of the device, either directly or as the result of additional processing (as indicated by stage 204 of the Figure). For a card not present transaction, the device data may be an IP address (Internet Protocol) associated with the consumer device, a wireless network cell identifier, or other data that may be used to generate a location or geographical region corresponding to the device (and by inference to the account used for the transaction). For a card present transaction, the device data may be a zip code or other geographical location identifier for the point of sale terminal used for the transaction or another indicator of the location associated with the transaction. Additional processing as required, including but not limited to, re-formatting, data conversion or filtering may be performed to prepare the location data for comparison.

Note that in accordance with some embodiments of the invention it is assumed that the location associated with the card present transaction is valid or correct, and that comparison with the location imputed to the consumer device used in a card not present transaction may be used to determine the validity or trustworthiness of that device or the account used for the transaction initiated using the device. After determining the location for the card present transaction and for one or more card not present transactions (stage 204), it is determined whether the location for one of the card not present transactions (Transaction #1 or Transaction #2 in the figure) is substantially the same (e.g., approximately the same or within a predetermined acceptable amount of variation) as the location for the card present transaction (stage 206). If the location for one of the card not present transactions is substantially the same as the location for the card present transaction, then the consumer device used for that card not present transaction is accepted as reliable and considered seasoned (stage 208). Similarly, the consumer account used in the transaction may then be considered reliable or seasoned if the account had not previously been considered reliable, etc. This determination may be recorded in a data store of the payment processing node or payment processor and used as the basis for authorization decisions made by the payment processor for future transactions initiated by the device. However, if the location for a card not present transaction is not substantially the same as the location for the card present transaction, then the consumer device or account used for that transaction is not accepted as reliable and is not considered seasoned (stage 210). In this situation no further action is taken with regards to identifying one or more of the consumer devices as seasoned, although in some situations a challenge or other form of request for confirming data may be issued.

Note that in some embodiments, when comparing the location or geographic region for a card present and a card not present transaction, “substantially the same” may be interpreted as meaning that the locations for the two transactions are close enough to conclude that a consumer who utilized a merchant for the card present transaction would likely be in the location imputed to the card not present transaction. This may mean, for example, that both locations are approximately the same or within a reasonable or predefined distance from the consumer's home or work.

Another way to interpret “substantially the same” is to identify what difference in locations would be sufficient to not constitute substantially the same for purposes of the seasoning or authorization decision. For example, it could be determined that the difference between the two locations is too great to justify identifying the consumer device used in the card not present transaction as seasoned if it is unlikely that the same consumer would conduct transactions in the two locations because of their separation (or because of the timing and separation of the two transactions). As noted, in such a case a challenge may be issued to assist the payment processor in deciding whether to authorize the card not present transaction.

As described with reference to FIG. 2, location data is used to discriminate between potentially valid and invalid consumer devices used in card not present transactions. However, the invention is not limited to consideration of location or geographical information as the determining data or information. In general, the invention uses data from a card present transaction to determine the validity of a card not present transaction (or the reliability or trustworthiness of a consumer device or account used in such a transaction), or to discriminate between multiple card not present transactions and determine which of those is valid or reliable. In performing this determination, data other than location information, and which is part of the transaction data or device identification data may be used.

In this regard, there are many data or data types for which similarity between the card present and card not present transactions would justify accepting the card not present transaction as valid (or the consumer device used in that transaction as seasoned). Exemplary data that may be used include access codes, security codes, identification data, challenge response data, a transaction history of accepted or recurring transactions using an account, etc.

Note that the determination that a device or account is reliable and should be considered seasoned may be communicated to the merchant involved in the transaction (or to other merchants) to enable the merchant or merchants to use that information as part of deciding whether to accept or approve subsequent transactions received from the same device or using the same account.

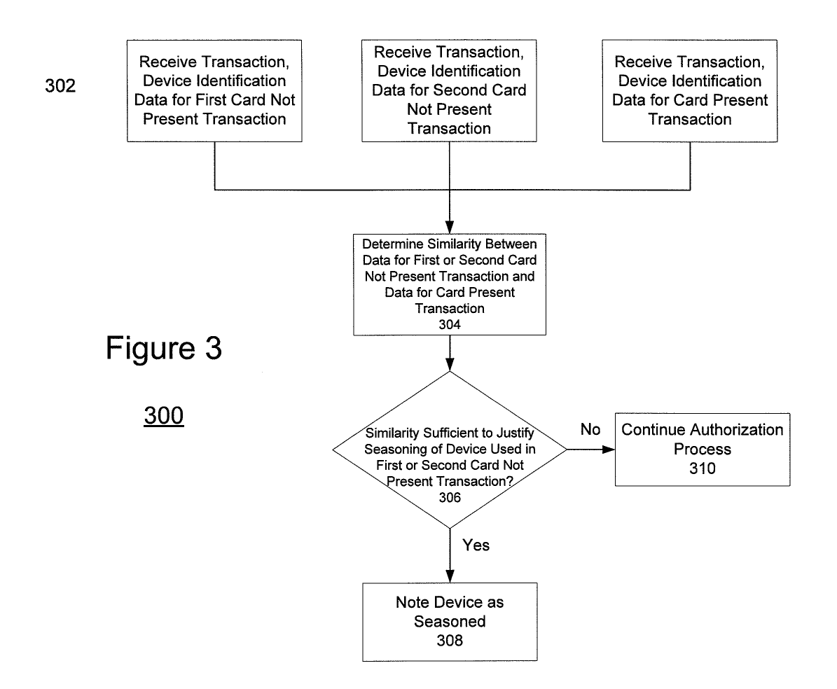

FIG. 3 is a flowchart illustrating a second method for seasoning a consumer device used in a card not present transaction, in accordance with some embodiments of the present invention. As shown in the figure, transaction and/or device identification data is received from a card present transaction and from one or more card not present transactions (stage 302). As noted with reference to FIG. 2, the steps or stages shown in FIG. 3 may represent the entire process of determining that a consumer device should be considered seasoned, or only a portion of the overall process. Further, although the process described with reference to FIG. 3 will typically be performed by a processor executing a set of instructions, for example a payment processing network node, it may also be performed by other nodes of an authorization network.

Exemplary card not present transactions include E-commerce transactions initiated by a consumer device in communication with a remote merchant over a communications network. Exemplary card present transactions include purchases at a merchant's physical location or via a point of sale terminal (such as at a gas station, etc.). Note that the card not present transactions may be one or more in number, with the invention determining whether the consumer device used for the card not present transaction is reliable and should be considered seasoned (in the case of one such transaction) or determining which (if any) of several consumer devices used to initiate transactions is reliable and should be considered seasoned (in the case of more than one such transaction). Note also that although shown as providing the transaction or device data in the same stage, embodiments of the invention include providing the data separately over a period of time, with previously received data being stored and accessed as needed for the data processing stages of the invention.

After receipt of the device identification and/or transaction data from a card present and one or more card not present transactions, the received data is processed to determine similarities between the data for the card present transaction and the data for the one or more card not present transactions (stage 304). In processing the data, data values for the same or similar data types or categories may be compared (e.g., those corresponding to the same “tag” or heading), or another suitable processing method may be utilized. For example, the location or geographical region corresponding to the card present transaction may be determined from the location of the point of sale terminal or merchant and this information may be compared (after any necessary conversions, formatting, etc.) to the location imputed to the consumer device or account used in the card not present transaction(s) (again after any necessary conversions, processing, etc.).

However, instead of, or in addition to location data, other data types or categories may be considered as the basis for determining that a particular consumer device or account is reliable and should be identified as seasoned. For example, if a different category or type of data was found to have the same or similar values for both the card present and a card not present transaction, then that category could be evaluated to determine if it was sufficient to use as the justification for deciding that the consumer device or account was reliable and could be identified as seasoned. Such a different category of data might include security or other access control data that was required for transaction authorization, identification data, challenge response data, a transaction history of accepted or recurring transactions using an account, etc. Thus, in some embodiments, the invention may include processing the received data to identify similar data types or categories, and then determining if the similarity of those types or categories and their values justifies identifying a consumer device or account as seasoned. In other embodiments, the invention may include determining the values of previously identified data categories and then determining if the values are sufficiently similar to justify identifying a consumer device or account as seasoned. In either case the intention is to decide if data type or category similarities, or data values are sufficient to justify seasoning the consumer device or account used in a card not present transaction (stage 306).

If the data is found to be sufficient to justify seasoning the consumer device, then the device is identified as seasoned (stage 308). In addition, as noted, the account used for the transaction may also be identified as seasoned if it had not previously been considered reliable. This determination may be recorded in a data store of the payment processing node or payment processor and used as the basis for authorization decisions made by the payment processor with regards to future transactions initiated by the device. If the data is not found to be sufficient to justify seasoning the consumer device or account, then the device or account is not identified as seasoned and in some embodiments a standard authorization process is executed (stage 310). This may include issuance of one or more challenges or other requests for information from the consumer or merchant as a pre-condition for authorization of the card not present transaction.

A discussed with reference to FIG. 2, the determination that a device or account is reliable and should be considered seasoned may be communicated to the merchant involved in the transaction (or to other merchants) to enable the merchant or merchants to use that information as part of deciding whether to accept or approve subsequent transactions received from the same device or using the same account.

The following description of use cases or possible scenarios in which the present invention might be used are intended as exemplary and not exhaustive, as other implementations and embodiments will be apparent to those of skill in the art.

In an illustrative embodiment or use case, a payment processor may receive data including an account number for a first transaction from a consumer device having an IP address corresponding to a first location or region, and data including the same account number for a second transaction from a consumer device having an IP address corresponding to a second, different location or region. Further, the payment processor may receive transaction data including the account number as part of a card present transaction from a merchant located in the same or approximately the same location or region as the first transaction.

In some embodiments of the invention, the payment processor may then determine that the location or region corresponding to the first transaction is accurate and that the IP address corresponding to that location or region is associated with a valid consumer device, but that the IP address corresponding to the second location or region is not associated with a valid device (e.g., because the second location or region differs significantly from the location for the card present transaction). In response, the payment processor may update its database to indicate that the device associated with the first transaction may be considered seasoned. The payment processor may also update its database to indicate that the device associated with the second transaction should be considered fraudulent or subject to further restrictions.

In another exemplary scenario or use case, a payment processor may receive data including an account number from a merchant as part of a card present transaction and data including the same account number for a card not present transaction, where the card not present transaction was initiated by a consumer device having an IP address corresponding to a location or region. In some embodiments of the invention, the payment processor may then determine whether the location of the merchant is substantially the same or approximately the same as the location imputed to the consumer device based on the IP address. If so, then the consumer device initiated transaction may be authorized and/or the consumer device identified as seasoned.

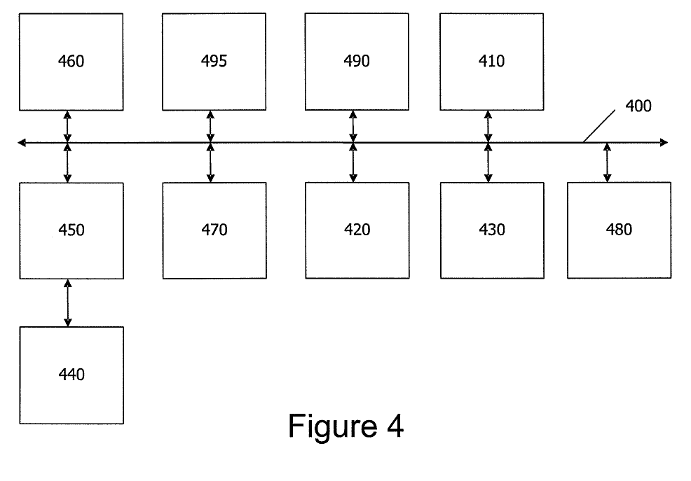

In some embodiments, the inventive methods, processes or operations for expediting the authorization of a payment transaction or seasoning a consumer device may be wholly or partially implemented in the form of a set of instructions executed by a central processing unit (CPU) or microprocessor. The CPU or microprocessor may be incorporated in a server or other computing device operated by, or in communication with, a node of the authorization network. As an example, FIG. 4 is a block diagram of elements that may be present in a computer device or system configured to execute a method or process for expediting the authorization of a payment transaction in accordance with some embodiments of the invention. The subsystems shown in FIG. 4 are interconnected via a system bus 400. Additional subsystems such as a printer 410, a keyboard 420, a fixed disk 430, a monitor 440, which is coupled to a display adapter 450, and others are shown. Peripherals and input/output (I/O) devices, which couple to an I/O controller 460, can be connected to the computer system by any number of means known in the art, such as a serial port 470. For example, the serial port 470 or an external interface 480 can be used to connect the computer apparatus to a wide area network such as the Internet, a mouse input device, or a scanner. The interconnection via the system bus 400 allows a central processor 490 to communicate with each subsystem and to control the execution of instructions that may be stored in a system memory 495 or the fixed disk 430, as well as the exchange of information between subsystems. The system memory 495 and/or the fixed disk 430 may embody a computer readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a,” “an” or “the” is intended to mean “at least one,” unless specifically indicated to the contrary.

What is claimed is:

1. An apparatus for authorizing an electronic payment transaction for a consumer, comprising:
a processor configured to execute a set of instructions;
a memory coupled to the processor for storing the set of instructions; and
the set of instructions stored in the memory, wherein when executed by the processor the instructions implement a method to
receive transaction data including an IP address and an account number for a first transaction;
receive transaction data including the account number for a second transaction, the second transaction being conducted at a merchant in a card present transaction;
determine if the first and second transactions were conducted in approximately the same geographic location; and
if the first and second transactions were conducted in approximately the same geographic location, then identify the device with the IP address as seasoned.

2. The apparatus of claim 1, wherein the instructions which when executed by the processor implement a method to determine if the first and second transactions were conducted in approximately the same geographic location, further comprise instructions which when executed by the processor implement a method to:
associate the IP address with a geographic location;
determine a geographic location of the merchant; and
compare the geographic location associated with the IP address to the geographic location of the merchant.

3. The apparatus of claim 1, wherein the IP address is associated with a consumer device.

4. The apparatus of claim 3, wherein the consumer device is a computer.

5. The apparatus of claim 3, wherein the consumer device is a mobile phone.

6. A method comprising:
receiving transaction data including an IP address and an account number for a first transaction;
receiving transaction data including the account number for a second transaction, the second transaction being conducted at a merchant in a card present transaction;
determining if the first and second transactions were conducted in approximately the same geographic location; and
if the first and second transactions were conducted in approximately the same geographic location, then identifying the device with the IP address as seasoned.

7. The method of claim 6, wherein determining if the first and second transactions were conducted in approximately the same geographic location further comprises:
associating the IP address with a geographic location;
determining a geographic location of the merchant; and
comparing the geographic location associated with the IP address to the geographic location of the merchant.

8. The method of claim 6, wherein the IP address is associated with a consumer device.

9. The method of claim 8, wherein the consumer device is a computer.

10. The method of claim 8, wherein the consumer device is a mobile phone.

11. The method of claim 6, further comprising if the first and second transactions were not conducted in approximately the same geographic location, then identifying the device with the IP address as potentially fraudulent.

12. A method, comprising:
receiving data for a card present transaction;
receiving data for a card not present transaction initiated by a consumer device;
determining a location corresponding to the card present transaction;
determining a location corresponding to the card not present transaction;
comparing the location corresponding to the card present transaction to the location corresponding to the card not present transaction, wherein if the two locations are approximately the same, then identifying the consumer device used to initiate the card not present transaction as seasoned.

13. The method of claim 12, wherein receiving data for a card not present transaction initiated by a consumer device further comprises receiving an IP address associated with the consumer device, and further, wherein determining a location corresponding to the card not present transaction further comprises using the IP address to determine the location.

14. The method of claim 12, wherein the consumer device is a computer.

15. The method of claim 12, wherein the consumer device is a mobile phone.

16. A method comprising:
receiving data for a card present transaction, the data including an account number;
receiving data for a first card not present transaction initiated by a first consumer device, the data including the account number;
receiving data for a second card not present transaction initiated by a second consumer device, the data including the account number;
determining a location for the card present and the first and second card not present transactions;
determining if the location for the first card not present transaction is approximately the same as the location for the card present transaction, wherein if the location for the first card not present transaction is approximately the same as the location for the card present transaction, then identifying the first consumer device as seasoned; and
determining if the location for the second card not present transaction is approximately the same as the location for the card present transaction, wherein if the location for the second card not present transaction is approximately the same as the location for the card present transaction, then identifying the second consumer device as seasoned.

17. The method of claim 16, wherein the first consumer device is one of a personal computer, laptop computer, mobile phone or PDA.

18. The method of claim 16, wherein the second consumer device is one of a personal computer, laptop computer, mobile phone or PDA.

19. The method of claim 16, further comprising:
if the location for the first card not present transaction is not approximately the same as the location for the card present transaction, then identifying the first consumer device as potentially fraudulent.

20. The method of claim 16, further comprising:
if the location for the second card not present transaction is not approximately the same as the location for the card present transaction, then identifying the second consumer device as potentially fraudulent.

21. A method comprising:
receiving data for a card present transaction;
receiving data for a card not present transaction initiated by a consumer device;
identifying a data category of the data for the card present transaction that is equivalent to a data category of the data for the card not present transaction;
comparing a value of data in the data category of the data for the card present transaction to a value of data in the data category of the data for the card not present transaction; and
identifying the consumer device as seasoned if the value of data in the data category of the data for the card present transaction and the value of data in the data category of the data for the card not present transaction are approximately the same.

22. The method of claim 21, wherein the data category for the card present transaction that is equivalent to a data category of the data for the card not present transaction is one of a group consisting of location, an access code, a security code, account or user identification data, challenge response data, or transaction data from accepted or recurring transactions using an account,

23. The method of claim 21, further comprising if the value of data in the data category of the data for the card present transaction and the value of data in the data category of the data for the card not present transaction are not approximately the same, then identifying the consumer device as potentially fraudulent.
